(19) United States
(12) Patent Application Publication
(10) Pub. No.: US 2025/0001980 A1
(43) Pub. Date: Jan. 2, 2025

(54) COMPRESSED-AIR SUPPLY SYSTEM

(71) Applicant: Aircom Automotive Sp. z o.o. Sp. k., PIETRZYKOWICE (PL)

(72) Inventors: Dominik Gschwender, Steckborn (CH); Jakub Jeskowiak, Ujazd Górny (PL)

(21) Appl. No.: 18/708,910

(22) PCT Filed: Nov. 18, 2022
(86) PCT No.: PCT/EP2022/082399

§ 371 Date: May 9, 2024

(30) Foreign Application Priority Data
Nov. 18, 2021 (DE) 20 2021 106 288.6

(51) Int. Cl. B60S 5/04

(52) U.S. Cl. CPC B60S 5/046

(57) ABSTRACT

The invention relates to a compressed-air supply system, in particular for supplying air for tires of a motor vehicle, comprising a compressor having an electric motor, in particular for driving a compressor unit, the compressor unit having a piston that is guided in a cylinder. The piston is coupled to the electric motor via a gearing. A gearwheel eccentrically coupled to the piston has counterweights, the at least one counterweight being snap-fitted in at least one slot of the gearwheel.

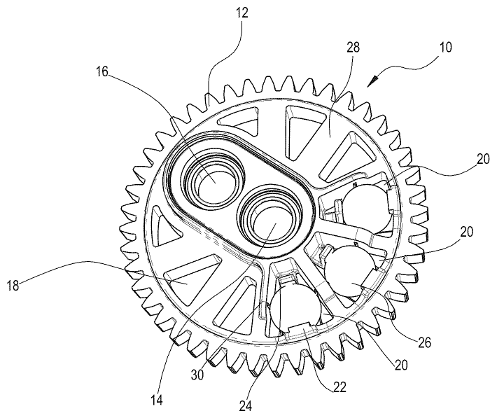

The invention relates to a compressed-air supply system, in particular for supplying air for tires of a motor vehicle.

Compressed-air supply systems are known from the prior art. For example, compressed-air supply systems that can be connected via a sealing liquid container to a pneumatic tire to be sealed are known. The sealing liquid container is, for example, connected to a compressor of the compressed-air supply system by an air inlet opening and connected to the tire by an outlet opening via which an air/sealing liquid mixture can exit. During operation of the compressor, sealant enters the tire in a state connected to the tire and can close an opening in the tire, and therefore allows continued travel after a flat tire without a spare tire having to be mounted. In particular, because of such compressed-air supply systems, carrying spare tires can be dispensed with, which improves the available space, for example in the trunk of a motor vehicle.

The compressor, in particular a compressor unit of the compressor, is driven, for example, with an electric motor, wherein the compressor unit has a piston guided in a cylinder, which piston is coupled to the electric motor via a gearing, wherein a gearwheel coupled eccentrically to the piston is provided with balancing weights to drive the piston in its lifting movement for compressing the air.

It is known in the prior art to provide a balancing weight which is held in a recess of the gearwheel by a weld. For this purpose, the balancing weight has, for example, an opening which is penetrated by a pin of the gearwheel and which is then deformed by means of heat so that the balancing weight is fixed in the recess. A disadvantage of such a design is that a plurality of different balancing weights must be kept available, or the selection is rather inflexible. In particular, these balancing weights have to be produced specifically for the application.

The object of the present invention is to provide a simple and flexible solution for balancing gearwheels in compressed-air supply systems.

This object is achieved by a compressed-air supply system with the features of claim 1. In this case, it is provided that the at least one balancing weight is snap-fitted in at least one recess of the gearwheel. In this way, a significantly simpler connection is possible which already takes place via the joining of the two parts and does not require an additional method step such as welding.

The compressor unit is driven via the electric motor which drives a drive gear via its motor shaft, which drive gear interacts with the gearwheel of the compressor unit. The piston is then eccentrically articulated to the gearwheel so that the rotation of the gearwheel causes a lifting movement of the piston in the cylinder during each rotation and accordingly compresses the air in the cylinder. This can then be passed through a sealant bottle as compressed air, wherein said compressed air is introduced into the tire with the entrainment of the sealant, and the sealant is transported therein where it seals an opening.

According to a preferred embodiment, the at least one balancing weight can be spherical. The advantage is thereby achieved that it is particularly easy to snap-fit in place without having to take the shape into account when fitting, since every installation position is the same. Incorrect installations are avoided.

Furthermore, it can preferably be provided that the at least one balancing weight is a ball bearing ball. In particular, ball bearing balls that do not meet the requirements for use in ball bearings can be used. In this way, another area of use can be found for them, and the employed balancing weights are comparatively inexpensive.

The balancing can be realized particularly well if a plurality of balancing weights, in particular three balancing weights, are provided. The provision of a plurality of balancing weights further increases the flexibility. In particular, the weights can be combined and arranged with one another in such a way that the desired effect results. It is also particularly advantageous that it is possible to use only one type of balancing weights of the same type and weight, in particular ball bearing balls. In particular, those that do not meet the high requirements for use in ball bearings can be used. This also reduces installation errors. Alternatively, however, balancing weights differing from each other which are used jointly are also conceivable.

It can preferably be provided that the at least one balancing weight is arranged opposite the axis of the gearwheel of the linkage of the piston and therefore forms the counterweight thereto. It can particularly preferably be provided that the at least one balancing weight is arranged so as to be point-symmetrical opposite the linkage of the piston and/or is arranged around this position when a plurality of balancing weights is used and they are preferably arranged symmetrically with respect to the point-symmetrical position. A particularly uniform distribution of the counterweight can thereby be achieved.

A particularly simple accommodation of the balancing weights can be achieved if the at least one recess is pie-slice-shaped (trapezoidal) and is equipped with latching elements. In such geometric recesses, spherical balancing weights in particular can be accommodated and held securely and simply. The latching elements can preferably be provided on the two sides of the recess that do not run towards each other.

Furthermore, it is preferably provided that one recess is provided per balancing weight, in which recess said weight is held in a latching manner. The flexibility can thereby be further increased since the individual balancing weights are independent of one another.

The gearwheel can preferably consist of plastics material, and the latching elements for the at least one balancing weight can be integrally connected to the gearwheel.

The balancing weights preferably consist of a metallic material, preferably steel.

Finally, it can be provided that the gearwheel has ribs which delimit the recesses and which rise from one of the end faces of the gearwheel. The guidance of the at least one balancing weight can thereby be further improved, and the at least one balancing weight is securely held.

For weight reasons or static reasons, further recesses can be provided in the gearwheel, or also ribs or grooves in the end faces which can completely or partially pass through the gearwheel.

Further advantages and features are apparent from the following description of an embodiment which is shown in the single FIGURE.

The single FIGURE shows a gearwheel 10 which has a conventional toothing 12 on its outer lateral surface. The gearwheel 10 furthermore has a central opening 14 via which it interacts with a motor shaft (not shown) of an electric motor and is rotatably driven thereby. Furthermore, the gearwheel 10 has another opening 16 in which a receptacle for a piston (not shown) can be provided for compressing air for a compressed-air supply system. The gearwheel 10 is part of the compressor unit of a compressor of the compressed-air supply system. The linkage for the piston is off-center, i.e. eccentric.

Furthermore, the gearwheel 10 has a row of recesses 18 and 20, wherein three recesses 20 are provided which are point-symmetrically opposite with respect to the central opening 14 of the receptacle 16 for the piston, or are arranged on both sides of the point-symmetry line. The recesses 20 are pie-slice-shaped or trapezoidal and each have latching elements 22 and 24 on their radially inward and radially outward facing sides which do not run towards each other. Spherical balancing weights 26 can be snap-fitted in the recesses 20 by means of these latching elements 22, 24.

Here, in particular ball bearing balls which can consist of steel are used as the balancing weights 26. The gearwheel 10 itself is designed as a plastics gear. The balancing weights 26 can be manually clipped into the recesses 20 and are then held in the recesses 20 by means of the latching elements 22 and 24.

Particularly uniform balancing of the eccentricity is provided by the arrangement on the point-symmetry line and on both sides thereof.

Furthermore, the end face 28 of the gearwheel 10 pointing upwards in the drawing plane has ribs 30 which are each arranged on both sides of the recesses 20 and, in addition to a stabilizing effect, also help hold the balancing weights 26. The ribs 30 can be designed in different widths, also in order to optimally configure the stability of the gearwheel 10.

In the described way, balancing of the gearwheel 10 in a compressed-air supply system can be realized in a particularly simple manner, wherein an individual and flexible adaptation of the balancing weights 26 can be easily realized, and in particular scrap ball bearing balls can be used economically for this purpose.

1. A compressed-air supply system, in particular for supplying air for tires of a motor vehicle, comprising a compressor having an electric motor, in particular for driving a compressor unit of the compressor, wherein the compressor unit has a piston guided in a cylinder, which piston is coupled to the electric motor via a gearing, wherein a gearwheel (10) which is coupled eccentrically to the piston is provided with balancing weights (26), characterized in that the at least one balancing weight (26) is snap-fitted in at least one recess (20) of the gearwheel (10).

2. The compressed-air supply system according to claim 1, wherein the at least one balancing weight (26) is spherical.

3. The compressed-air supply system according to claim 1, characterized in that the at least one balancing weight (26) is a ball bearing ball.

4. The compressed-air supply system according to claim 1, characterized in that a plurality of balancing weights (26), in particular three balancing weights (26), are provided.

5. The compressed-air supply system according to claim 1, characterized in that the at least one balancing weight (26) is arranged opposite the axis of the gearwheel (10) of the linkage (16) of the piston.

6. The compressed-air supply system according to claim 1, characterized in that the at least one balancing weight (26) is arranged point-symmetrically opposite the linkage (16) of the piston and/or is arranged around this position, preferably symmetrically to the point-symmetrical position.

7. The compressed-air supply system according to claim 1, characterized in that the at least one recesses (20) is pie-slice-shaped and is equipped with latching elements (22, 24).

8. The compressed-air supply system according to claim 1, characterized in that one recess (20) is provided per balancing weight (26), in which recess said weight is held in a latching manner.

9. The compressed-air supply system according to claim 1, characterized in that the gearwheel (10) consists of plastics material, and the latching elements (22, 24) for the at least one balancing weight (26) are integrally connected to the gearwheel (10).

10. The compressed-air supply system according to claim 1, characterized in that the gearwheel (10) has ribs (30) which delimit the recesses (20) and rise from the end face (28) of the gearwheel (10).
